(19) United States
(12) Patent Application Publication
(10) Pub. No.: US 2007/0180214 A1
(43) Pub. Date: Aug. 2, 2007

(54) System and method for dynamic striping in a storage array

(75) Inventors: Ramesh Radhakrishnan, Austin, TX (US); Amina Saify, Austin, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 11/312,968

(22) Filed: Dec. 20, 2005

(51) Int. Cl. G06F 12/00; G06F 12/16

(52) U.S. Cl. 711/202; 711/114

(57) ABSTRACT

A system and method is disclosed that provides for the dynamic striping of the disks of a storage array. The system and method disclosed herein provides a technique for translating access commands in a manner that is specific to the stripe that is the target of the access command. When a storage controller receives the access command, the storage controller identifies the logical block that is the subject of the access command, and the stripe that includes the logical block. On the basis of the identification of the stripe, the storage controller retrieves a stripe-specific translation function, the input of which is the logical address of the access command. After the storage controller executes the stripe-specific translation function, the storage controller completes the access command at the translated address.

### TECHNICAL FIELD

The present disclosure relates generally to computer systems and information handling systems, and, more particularly, to a system and method for dynamic striping in a storage array.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

An information handling system or computer system may be coupled to a network that that includes a fault tolerant storage array. One example of a fault tolerant storage array is RAID storage. RAID storage typically involves a storage array comprised of several disks. The disks are collectively managed by a storage controller. RAID storage arrays are characterized by the ability to restore or rebuild the information on a drive following a failure. On the disks of the array, data is saved in the form of stripes, which extend across each of the disks of the array. A single stripe is typically comprised of stripe elements or strips. If a stripe includes only a single strip in each disk, the stripe has a depth of one. If the stripe includes three strips in each disk, the stripe has depth of three. The size of a stripe is defined as the depth of the stripe times the number of disks in the stripe. In the previous example, if the stripe depth is three and there are three disks in the stripe, the stripe size is nine. An array may include multiple stripes, and each stripe may be accessed by multiple applications. Depending on the data access patterns of the various applications that access a particular stripe, it may not be most efficient for each stripe of the array to have the same stripe size.

### SUMMARY

In accordance with the present disclosure, a system and method is disclosed that provides for the dynamic striping of the disks of a storage array. The system and method disclosed herein provides a technique for translating access commands in a manner that is specific to the stripe that is the target of the access command. When a storage controller receives the access command, the storage controller identifies the logical block that is the subject of the access command. The storage controller identifies the stripe that includes the logical block. On the basis of the identification of the stripe, the storage controller retrieves a stripe-specific translation function, the input of which is the logical address of the access command. After the storage controller executes the stripe-specific translation function, the storage controller completes the access command at the translated address.

The system and method disclosed herein is technically advantageous because it provides a technique that allows a single array to include stripes of varying sizes. As such, the stripes of the array can be sized to best accommodate the characteristics of the applications accessing the stripes or the data content of the stripes. The system and method provides for stripe-specific translation functions, each of which is associated with a stripe and performs the step of translating logical to physical addresses according to the parameters of the associated stripe.

Another technical advantage of the system and method disclosed herein is that the mapping functions are stored in a location that is immediately accessible to the processing resources of the storage controller. As such, the storage controller can easily access the mapping table and the mapping functions without the necessity of accessing a storage location that is exterior to the storage controller. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of a storage network;

FIG. 2 is a diagram of a mapping table;

FIG. 3 is a diagram of the selection of a mapping function; and

FIG. 4 is a flow diagram of a method for the stripe-specific mapping of logical access commands to physical access commands for an array that includes stripes of different sizes.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

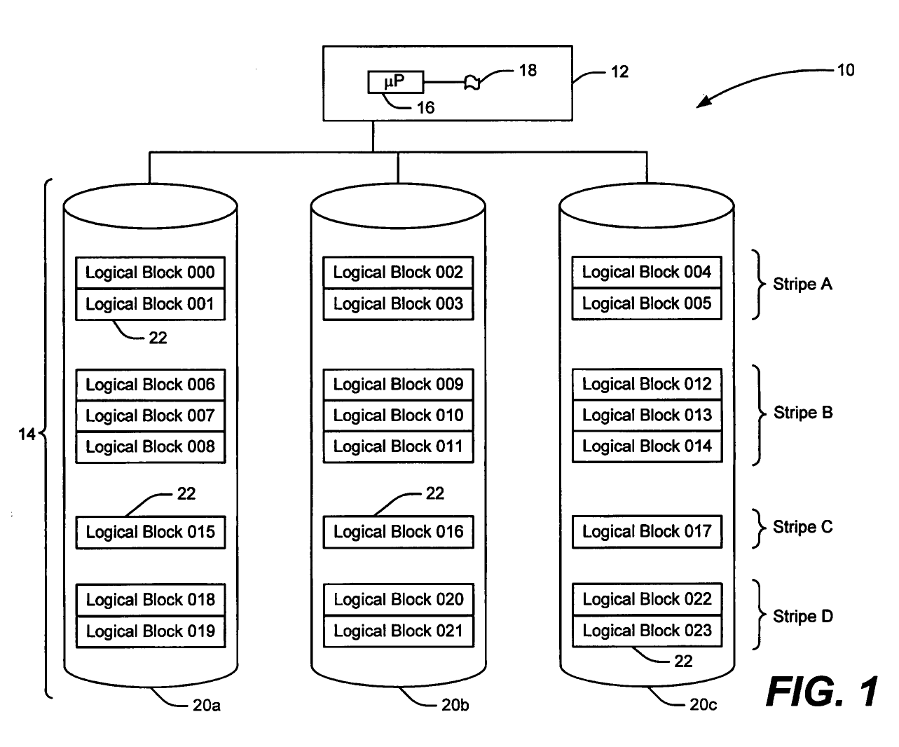

Shown in FIG. 1 is a diagram of a network 10, which includes a RAID array 14 coupled to a storage controller 12. Storage controller 12 includes a processor 16 and a storage location 18. RAID array 14 includes three disks 20, which are identified as disks 20a, 20b, and 20c. Each disk 20 includes a number of strips or logical blocks 22. Storage controller manages the operation of RAID array 14. In operation, the storage controller converts the logical address of an access command (read or write command) to a physical address. In operation, storage controller 12 includes a number of mapping functions, each of which is associated with a stripe of the array. Depending on the stripe that is the target of the access command, the storage controller executes the corresponding mapping function to map the logical address of the access command to a physical address.

The RAID array in the example of FIG. 1 includes four stripes. Each stripe includes multiple strips, which are identified as Virtual Block 001 through Virtual Block 023. Stripe A, which includes Logical Block 001 through Logical Block 005, has a stripe depth of two and a size of six. Stripe B, which includes Logical Block 006 through Logical Block 014, has a stripe depth of three and a stripe size of nine. Stripe C, which includes Logical Block 015 through Logical Block 017, has a stripe size of four. Stripe D, which includes Logical Block 018 through Logical Block 023, has a stripe size of six. There are three different stripe sizes among the four stripes in the array. The size of each stripe has been set to most efficiently accommodate the data access pattern associated with the data in the stripe.

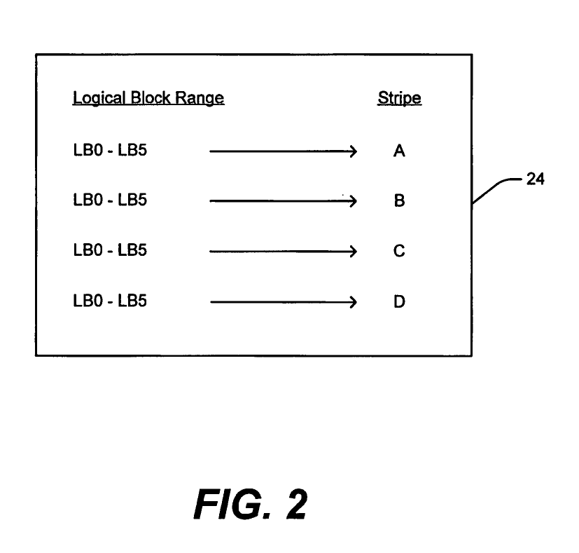

Because the stripes of the array are not of a uniform size, a mapping function is associated with each of the stripes. Shown in FIG. 2 is a mapping table 24 depicting an association between the logical block of the access command and the stripe. As indicated in FIG. 2, when the storage controller receives an access commands, the access commands associates with the command with a stripe according to strip or logical block that is the target of the access command. In the example of FIG. 2, if the access command was targeted to data in logical block 7, the storage controller would access the table to determine that the logical block is in Stripe B. With reference to FIG. 1, the table of FIG. 2 is stored in storage location 18 in storage controller 12. Processor 16 of storage controller is able to access the data of storage location 18, including table 24.

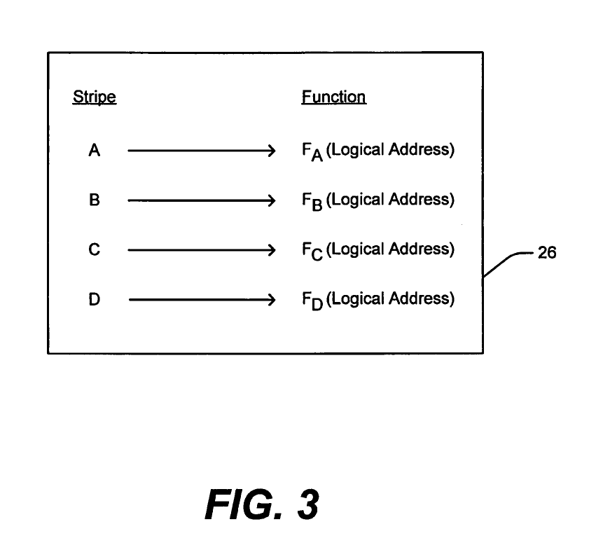

Shown in FIG. 3 is a diagram 26 depicting the selection of a mapping function on the basis of the identification of the stripe associated with the access command in the table of FIG. 2. Each stripe is associated with a unique mapping function. The mapping functions are also stored in storage location 18 in the storage controller. Because the mapping functions and mapping table are stored in local memory in the storage controller, the storage controller can quickly and efficiently access the mapping functions and mapping table. As an example, if it is determined in table 24 of FIG. 2 that the access command is attempting to access a logical block in Stripe B, the controller would select the function associated with Stripe B, which is F_{B}(Logical Address). The variable input to the function is the logical address of the access command and the output of the function is the physical address of the access command. Each mapping function applies the parameters of the stripe associated with the mapping function to generate a physical address on the basis of the logical address that is the input of the mapping function. The parameters of each stripe include the depth of the stripe of the offset of the stripe from the first stripe or the top of the disk

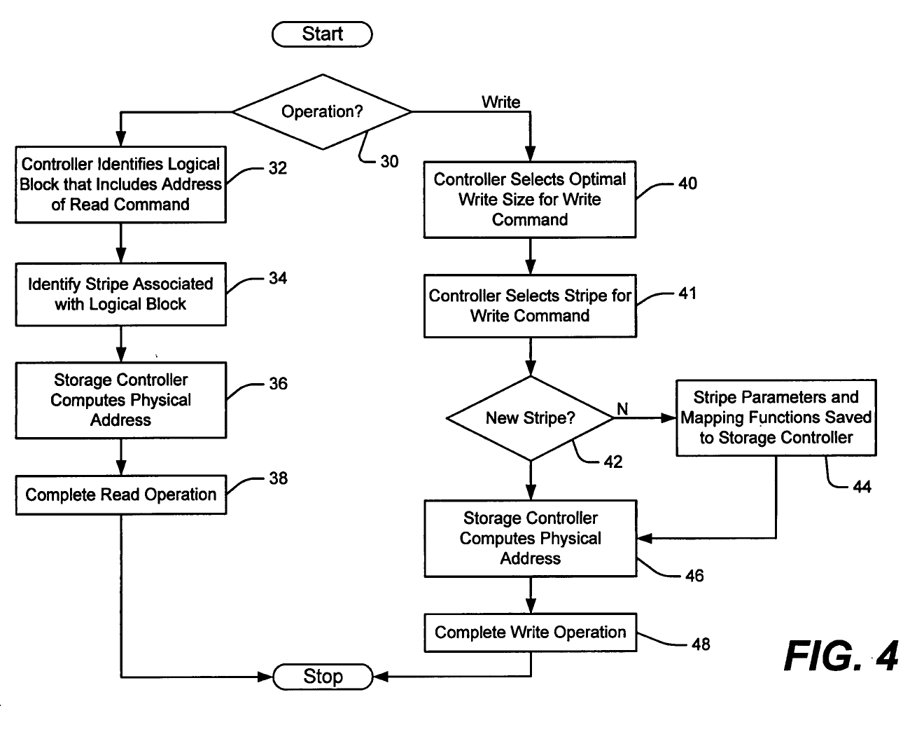

Shown in FIG. 4 is a flow diagram of a series of method steps for the stripe-specific mapping of logical access commands to physical access commands for an array that includes stripes of different sizes. At step 30, the storage controller determines if the access command is a read command or a write command. If the access command is a read command, the storage controller at step 32 identifies the logical block that includes the address of the access command. At step 34, the storage controller accesses table 24 to identify the stripe associated with the logical block. Following the identification of the stripe that includes the target of the access command, the storage controller computes at step 36 the physical address associated with the logical address. This computation is accomplished by selecting and executing the function associated with the stripe, with the input to the function being the logical address of the read command. Once the physical address is determined from the function, the read operation is completed at step 38 with the physical address of the access command.

If it is determined at step 30 that the access command is a write command, the controller at step 40 determines the optimal stripe size for the write command. The determination of the optimal stripe size for the write command can be determined on the basis of several factors, including the type of application that issued the write command and the amount of data to be written as part of the write command. Once the controller identifies the optimal stripe for the write command, the controller determines identifies a stripe that has the stripe size that is closet to the determined optimal stripe size. The selected stripe can be an existing stripe of a new stripe. A new stripe is a stripe that has not yet been written to. If it is determined at step 42 that the selected stripe is a new stripe, the stripe size and the range of logical blocks associated with the stripe is saved at step 44 to the storage location in the storage controller. After the parameters of the stripe are saved to the storage location in the storage controller, the storage controller computes at step 46 the physical address associated with the target of the write operation. Likewise, if it is determined at step 42 that the selected stripe is not a new stripe, the storage controller computes the physical address associated with the target of the write operation at step 46.

The computation of the physical address associated with the logical address of the write command involves the selection and execution the function associated with the stripe. The input to the function is the logical address of the write command. Once the physical address is determined from the function, the write operation is completed at step 48 with the physical address of the access command. As such, once the stripe has been identified, a stripe-specific mapping function is executed to generate the physical address associated with the logical address of the write command.

It should be recognized that the system and method disclosed herein is not limited in its application to RAID arrays. Rather, this system could be implemented with reference to any array of disks that stores data in stripes of varying size. Although the present disclosure has been described in detail, it should be understood that various changes, substitutions, and alterations can be made hereto without departing from the spirit and the scope of the invention as defined by the appended claims.

What is claimed is:

1. A method for translating the address of a data access command in a storage controller, wherein the storage controller is coupled to an array of disks, and wherein the array of disks include multiple stripes of data of varying size, and wherein each stripe is uniquely associated with a mapping function, comprising:
receiving the data access command;
identifying the stripe that is the target of the data access command;
selecting the mapping function that is uniquely associated with the stripe that is the target of the data access command;
executing the function to generate a physical address for the data access command; and
completing the data access command with the generated physical address.

2. The method for translating the address of a data access command in a storage controller of claim 1, wherein the array of disks is configured according to a fault tolerant storage format.

3. The method for translating the address of a data access command in a storage controller of claim 2, wherein the array of disks is configured according to a RAID format.

4. The method for translating the address of a data access command in a storage controller of claim 1, wherein the step of identifying the stripe that is the subject of the data access command comprises the step of identifying the logical block that is the target of the data access command and identifying the logical block that includes the targeted logical block.

5. The method for translating the address of a data access command in a storage controller of claim 4, wherein the stripe is identified on the basis of a table that identifies the stripe associated with each logical block in the array of disks.

6. The method for translating the address of a data access command in a storage controller of claim 5, wherein the table is saved to storage in the storage controller.

7. The method for translating the address of a data access command in a storage controller of claim 1, wherein the mapping functions are saved to storage in the storage controller.

8. The method for translating the address of a data access command in a storage controller of claim 1, further comprising the step of, if the data access command is a write command:
determining if the identified stripe is a new stripe; and
if the identified stripe is a new stripe, saving the parameters of the stripe and the mapping function associated with the stripe to the storage controller.

9. The method for translating the address of a data access command in a storage controller of claim 1, wherein the parameters of the stripe include the depth of the stripe.

10. A storage network, comprising:
an array of disks, wherein the array of disks includes multiple stripes of data of varying size and wherein each stripe is uniquely associated with a mapping function;
a storage controller coupled to the array of disks, wherein the storage controller is operable to:
receiving the data access command;
identifying the stripe that is the target of the data access command;
selecting the mapping function that is uniquely associated with the stripe that is the target of the data access command;
executing the function to generate a physical address for the data access command; and
completing the data access command with the generated physical address.

11. The storage network of claim 10, wherein the mapping functions are saved to a storage location on the storage controller.

12. The storage network of claim 10, wherein the data of the arrays is configured according to a fault tolerant format.

13. The storage network of claim 10, wherein the data of the arrays is configured according to a RAID format.

14. The method for translating the address of a data access command in a storage controller of claim 10, wherein the storage controller is operable to identify the stripe that is the subject of the data access command by identifying the logical block that is the target of the data access command and identifying the logical block that includes the targeted logical block.

15. The method for translating the address of a data access command in a storage controller of claim 10, wherein the storage controller is operable to identify the stripe on the basis of a table that identifies the stripe associated with each logical block in the array of disks.

16. A method for translating a logical address to a physical address for transmission of a data access command to a disk in an array of disks, wherein the array of disks includes stripes of varying stripe size, comprising:
identifying the stripe that is the target of the logical command;
selecting one of a plurality of mapping function, wherein each mapping function is uniquely associated with a stripe of the array, and
executing the mapping function to generate a physical address on the basis of the logical address.

17. The method for translating a logical address to a physical address for transmission of a data access command to a disk in an array of disks of claim 16, wherein the disks of the array are formatted according to a fault tolerant format.

18. The method for translating a logical address to a physical address for transmission of a data access command to a disk in an array of disks of claim 17, wherein the disks of the array are formatted according to a RAID format.

19. The method for translating a logical address to a physical address for transmission of a data access command to a disk in an array of disks of claim 16, wherein the step of identifying the stripe that is the target of the logical command comprises the step of identifying the logical block that is the target of the data access command and identifying the stripe that includes the logical block.

20. The method for translating a logical address to a physical address for transmission of a data access command to a disk in an array of disks of claim 16, further comprising the step of transmitting the data access command to a disk in the array of disks according to the generated physical address.
